(19) United States
(12) Patent Application Publication
(10) Pub. No.: US 2005/0098001 A1
(43) Pub. Date: May 12, 2005

(54) Nut driver improvement

(76) Inventor: Russell Earl Walker, San Antonio, TX (US)

Correspondence Address: ALAN R THIELE;STRASBURGER & PRICE LLP, 901 MAIN STREET, SUITE 4300, Dallas, TX, 75202-3794, US

(21) Appl. No.: 10/704,313

(22) Filed: Nov. 7, 2003

(51) Int. Cl. B25B 23/00

(52) U.S. Cl. 81/439

(57) ABSTRACT

The disclosed invention includes a set of nested socket members, screw bits, an adaptor, and an elongated hollow handle with an array of additional accessories to improve the operability and utility of the basic tool.

### BACKGROUND OF THE INVENTION

1. Field

The present invention pertains to a small multi-purpose tool including a set of nested sockets and an array of screw bits.

2. Background

The present invention pertains to improvements for the nut driver multi-purpose tool described in U.S. Pat. No. 6,330,844 B1 to the same inventor.

Experience in using the nut driver multi-purpose tool described in U.S. Pat. No. 6,330,844 B 1 in its basic form has revealed that additional functionalities can be added to still further enhance the operability and usability of this handy tool. Such additional functionalities can be added to the tool without departing from its basic purpose—to provide the user with multiple capabilities in a tool that is easy to carry and easy to use for a wide range of light repair work.

### SUMMARY

The disclosed invention includes a set of improvements to the nut driver multi-purpose tool described in U.S. Pat. No. 6,330,844 B1 including:
a) color coding for identifying either the stored screwdriver bits or stored individual sockets;
b) reversible sockets;
c) a basin wrench attachment;
d) a strap wrench accessory;
e) a central universal joint;
f) a ratchet mechanism;
g) a knife or saw attachment mounted in the handle;
h) a motor drive;
i) an insulating gripper handle;
j) a bottle opener/wire insulation stripper mountable on the handle; and
k) a level placed within the elongated handle.

All of the foregoing improvements are based on the functionality afforded by the basic design of the nut driver multi-purpose tool and involve enhancements or attachments to increase its operability and usability.

### BRIEF DESCRIPTION OF THE DRAWING FIGURES

A better understanding of the improvements to the present invention may be had by reference to the drawing figures, wherein:

FIG. 1 is a perspective view of the nut driver multi-purpose tool as depicted in U.S. Pat. No. 6,330,884B1;

FIG. 2 is a perspective view of the nut driver multi-purpose tool including an exploded view of a plurality of nested sockets;

FIG. 2A is a perspective view of a reversible socket;

FIG. 2B is a side elevational view, in partial section, of the reversible socket shown in FIG. 2A;

FIG. 3 is an exploded perspective view of the mounting of a basin wrench accessory to the nut driver multi-purpose tool;

FIG. 3A is a perspective view of the mounted basin wrench accessory ready for use;

FIG. 4 is an exploded perspective view of the mounting of a universal joint accessory on the handle portion of the nut driver multi-purpose tool;

FIG. 5 is a perspective view of a ratchet accessory which is mountable on the handle portion of the nut driver multi-purpose tool;

FIG. 6 is a perspective view of a motor drive mechanism usable with the handle portion of the nut driver multi-purpose tool;

FIG. 7 is an exploded perspective view of the mounting of a strap wrench accessory mountable on the handle portion of the nut driver multi-purpose tool;

FIG. 7A is a perspective view of a strap wrench accessory mounted to the handle portion of the nut driver multi-purpose tool;

FIG. 8 is a perspective view of the mounting of a knife or hacksaw blade on the handle portion of the nut driver multi-purpose tool;

FIG. 8A is a perspective view of the knife or the hacksaw blade shown in FIG. 8 in its extended position;

FIG. 9 is a perspective view of a bottle opener/wire insulation stripper removal tool accessory mounted on the handle portion of the nut driver multi-purpose tool;

FIG. 10 is a perspective view of a level mounted in the handle portion of the nut driver multi-purpose tool; and

FIG. 11 is a perspective view of an insulating gripper accessory to be used over the handle portion of the nut driver multi-purpose tool;

### DESCRIPTION OF THE EMBODIMENTS

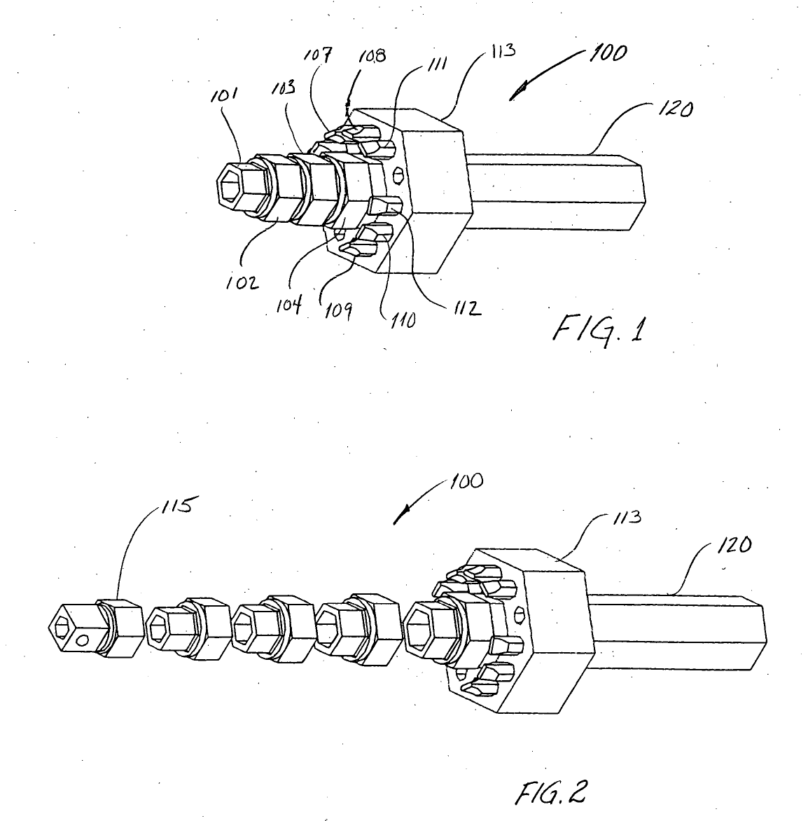

As will be understood by those of ordinary skill in the art, the present invention provides a set of improvements for the nut driver multi-purpose tool 100 which is described in U.S. Pat. No. 6,330,844 B1 and depicted in FIG. 1. The described nut driver multi-purpose tool 100 is a self-contained, multi-use tool enabling the insertion and removal of a range of different sizes of threadable fasteners. The tool 100 includes an array of screw bits 107, 108, 109, 110, 111 and 112, and a set of nested sockets 101, 102, 103, and 104, which can all be stored together and mounted on an elongated hollow handle 120. Because of the small size of the tool, it has been found that it can easily be placed in a holster worn on the belt of a user.

During actual use of the tool, it was noted that the tool provided a suitable foundation for a variety of other utilities and operations which are described herein.

As shown in FIG. 2A, additional sockets may be added to increase the range of sizes of threaded fasteners which can be engaged by the nut driver multi-purpose tool 100. As indicated in U.S. Pat. No. 6,330,844 B1, an adapter 115 is still used when a screw bit 107, 108, 109, 110, 111 and 112 is to be used.

In additional utilization of the disclosed nut driver, it has been found that yet other improvements are possible which also improve upon the usability and functionality of the tool. For example, it has been found that if the various sockets 101, 102, 103, and 104, are color coded, the user will be able to identify the sockets on a regular basis and will be able to easier find the desired socket when needed. Similarly, each of the screw bits 107, 108, 109, and 110 located in the collar 113 may be color coded to improve ease of location and selection. Such color coding system may take on a variety of different forms well known to those of ordinary skill in the art, such as dots, stripes, rings, etc.

As shown in FIGS. 2A and 2B, to increase the range of sizes of socket sizes available to the user to engage and turn threaded fasteners, it has been found that each of the nested sockets as shown in FIG. 1 and FIG. 2 can be made to be reversible so that standard hex sizes are available on either end of the socket 130. For example, if the large end is sized to fit a ⅞ in. threaded fastener, the smaller end will be sized to fit a smaller threaded fastener, e.g., ⅝ in. To gain access to the desired size of socket, the nest of sockets is taken apart and re-assembled so that the desired hex size is available to engage the threaded fastener. To facilitate use, the size (⅞) of the lower portion may be marked on one side as shown in FIG. 2A and the size of the upper portion marked on the opposite side (not shown).

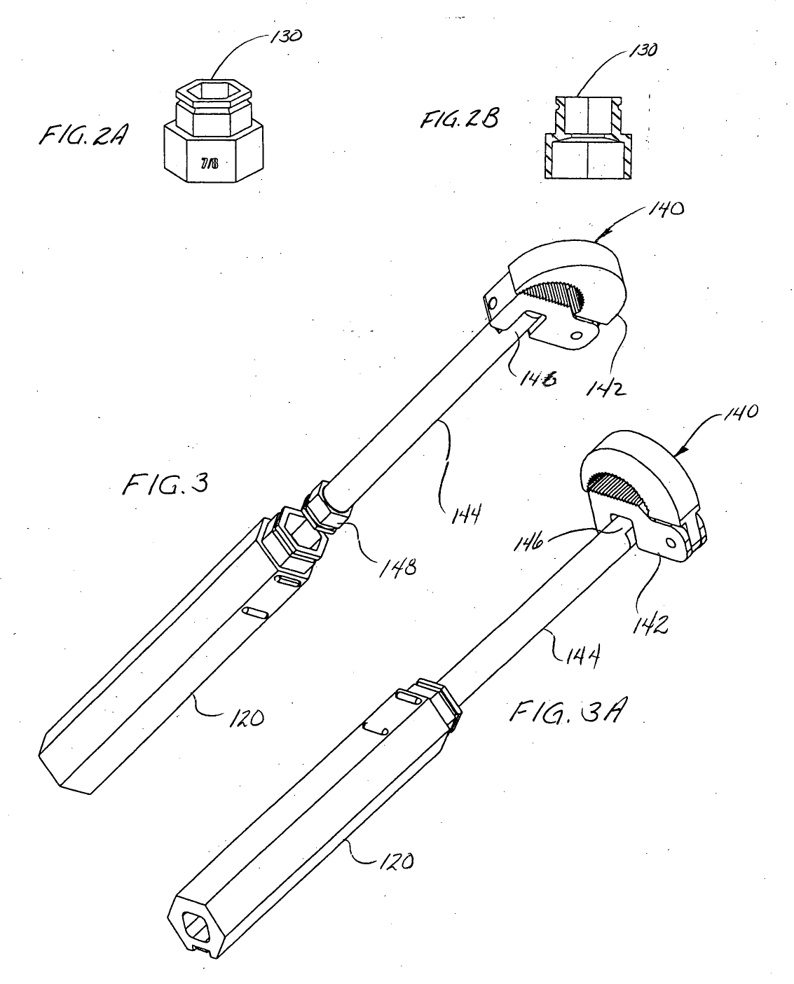

Yet another improvement is the addition of a basin wrench accessory 140 shown in FIG. 3 and FIG. 3A. The basin wrench accessory 140 may be utilized with the elongated hollow handle 120. Since the tool 100 is often used by plumbers, the addition of a basin wrench accessory 140 enables utilization of the tool 100 underneath a sink for the installation of a faucet. As shown in FIG. 3A, the ability of the head 142 of the basin wrench accessory 140 to turn to a right angle with respect to the extension shaft 144 is provided by the hinged mounting 146 of the head 142 to the extension shaft 144. At the opposite end of the basin wrench accessory 140 is a hex adapter 148 to provide mounting to the handle 120.

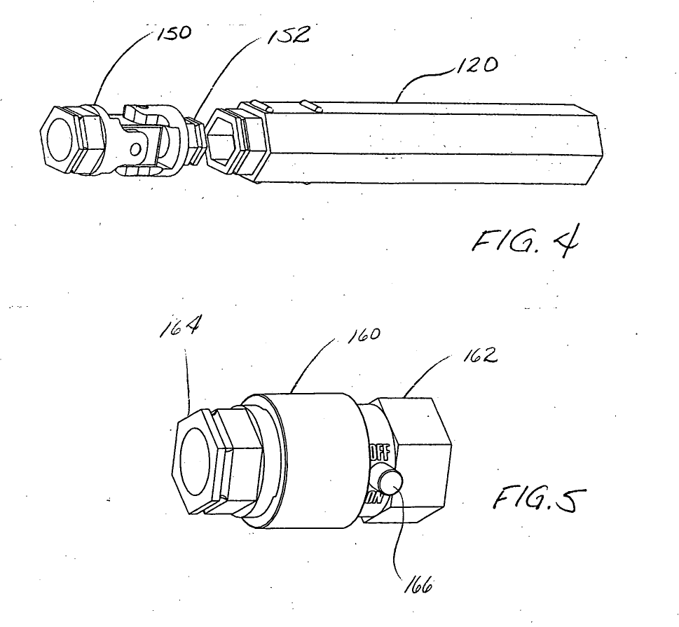

As shown in FIG. 4, to further facilitate utilization of the elongated hollow handle 120 with a variety of different sockets and a variety of different positions, it has been found that a universal joint accessory 150 may be added to the tool. A first hex end 152 on the universal joint accessory 150 is inserted into the elongated handle 120 when the universal joint accessory 150 is placed between the elongated handle 120 and a selected socket or combination of sockets.

In still other installations, it has been found that there is a need for a ratchet mechanism 160. Such ratchet mechanisms 160 are well known to the users of socket wrenches. The ratchet mechanism as depicted in FIG. 5 is sized to be mountable onto the elongated handle 120 on one end and includes an extension 162 for mounting a socket when the other end 164 is inserted into the elongated handle 120. As with most ratchet mechanisms, an indicator 166 reveals the direction in which the ratchet operates—for loosening (OFF) or tightening (ON) a threaded fastener.

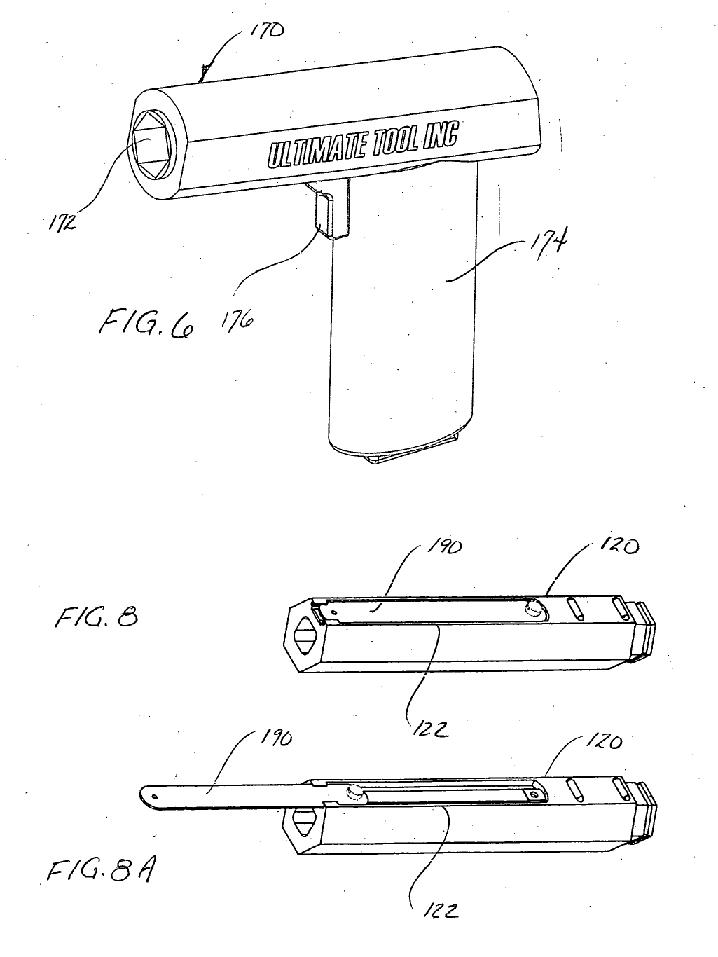

In some situations, it is necessary to utilize more force than that available from the grip of a human hand. In such situations, a motor drive assembly 170 may be needed. The motor drive assembly 170 as shown in FIG. 6 fits over the elongated hollow handle 120 and includes a hollow rotating member 172 therein. The hollow rotating member 172 is driven by a motor (not shown). The drive motor assembly 170 uses contact with flats on the hex shape of the exterior of the elongated hollow handle 120 to turn the elongated handle 120 by contact with the hollow rotating member 172 to provide a driving force for the tool 100. It has been found that the drive motor assembly 170 is also effective for reducing hand fatigue if the tool 170 is used for long periods of time or is used with extended length threaded fasteners. The drive motor may be housed in the handgrip 174 and interconnected with the hollow rotating member 172 by a belt or gear drive assembly. For controlling use, a trigger switch 176 may be included to provide an on/off switch or to regulate the speed or direction of rotation of the hollow rotating member 172.

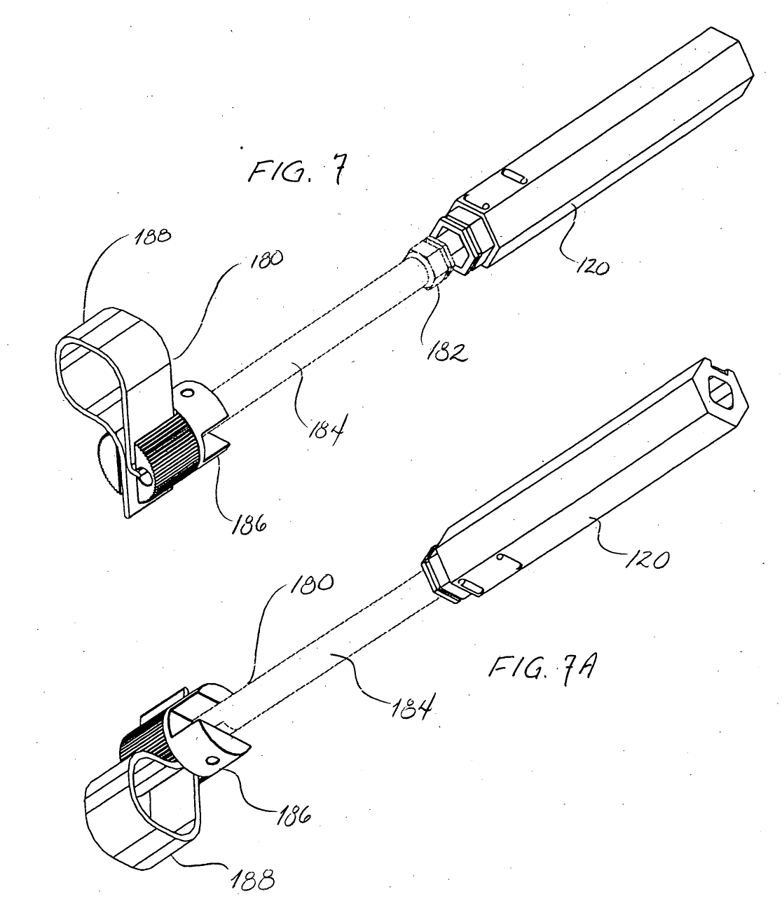

In unique situations, it may be necessary to turn or grip an odd-sized device such as a filter cartridge. When such an odd-sized device must be turned or gripped, it is often handy to utilize a strap wrench accessory 180 such as depicted in FIG. 7. Accordingly, a strap wrench accessory 180 similar to the basin wrench accessory 140 as shown in FIG. 3 and FIG. 3A, is provided for use with the handle portion 120 of the basic nut driver multi-purpose tool 100 of the present invention. As may be seen in FIG. 7, the strap wrench accessory 170 includes an adapter 182 for mating with the elongated handle 120, a shaft 184 to connect the strap mounting mechanism 186, and a strap 188 which may be placed, then tightened around the object to be turned.

As may be seen in FIG. 8 and FIG. 8A, the elongated hollow handle 120 may also include an accessory such as a knife blade 190. The knife blade 190 will extend outwardly from a recess 122 formed within the elongated hollow handle 120. When cutting plastic or anything which may be severed with a small sharpened blade 192, this accessory provides great utility. If desired, the knife blade 192 may be replaced with a hacksaw blade for cutting small pieces of metal. Alternatively, a knife blade 190 may be mounted on one side of the handle 120 and a hacksaw blade may be mounted on the other side.

In FIG. 9 is shown a flip-up device 200 which may be used to remove insulation from a piece of wire using the sharpened edge 202 of the bottom of a notch 204. Optionally located under the flip-up wire insulation remover 200 is a recess 206 and projection 208. The recess 206 and projection 208 may be used for removing bottle caps or opening up containers holding beverages or paint. The flip-up device 200 is contained within a recess 124 in the handle 120. If desired, the flip-up device 200 could be a knife blade.

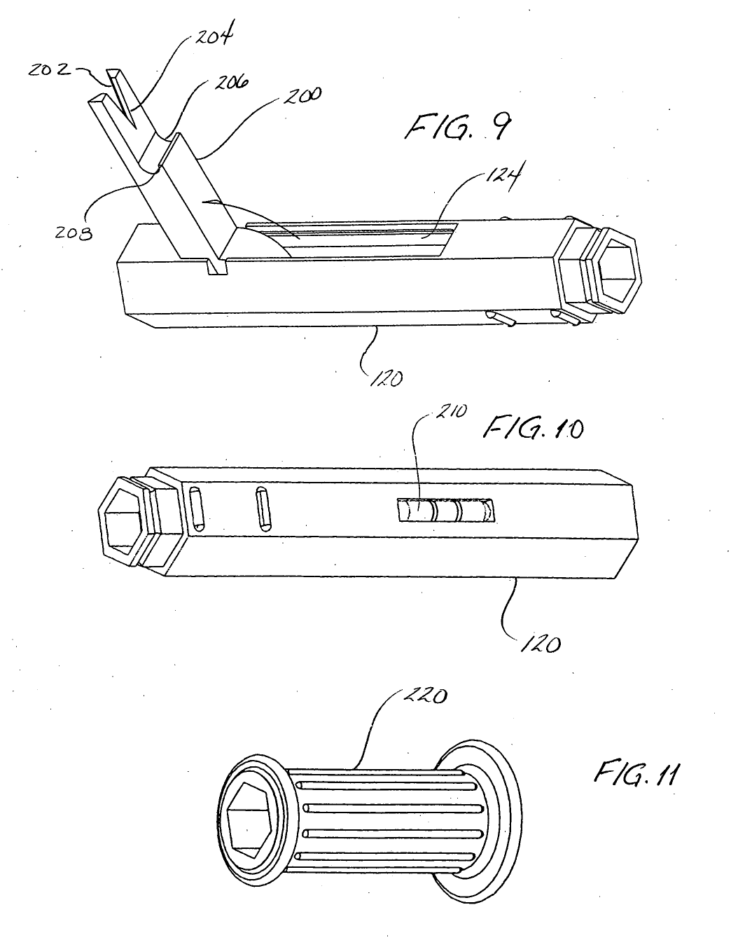

In FIG. 10 a bubble level 210 is shown mounted in the elongated hollow handle 120. The bubble level 210 may be used in any situation where it is appropriate to align the handle 120 with a horizontal surface.

FIG. 11 depicts a slip-on insulating handle 220 which may be slipped over the handle 120 to frictionally engage the handle 120 for obtaining a better grip or protecting the user against electrical shocks.

While the present set of improvements has been disclosed according to the preferred embodiment of the invention, those of ordinary skill in the art will understand that other embodiments have also been enabled. Such other embodiments shall fall within the scope and meaning of the appended claims.

1-13. (canceled)

14. A multi-use tool comprising:
an elongated hollow handle;
a set of nested reversible socket members wherein the largest of said set of reversible socket members engages one end of said elongated hollow handle;
a collar surrounding said elongated hollow handle, said collar constructed and arranged for holding an array of screwdriver bits.
